(19) United States
(12) Patent Application Publication
(10) Pub. No.: US 2005/0246229 A1
(43) Pub. Date: Nov. 3, 2005

(54) Systems and methods for disseminating information relating to a prize in connection with usage of consummable products

(75) Inventor: Steven W. Goldstein, Delray Beach, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: SMG TRUST, Delray Beach, FL (US)

(21) Appl. No.: 10/836,539

(22) Filed: Apr. 30, 2004

(51) Int. Cl. G06F 17/60

(52) U.S. Cl. 705/14; 705/1

(57) ABSTRACT

The present invention provides a marketing system and method for motivating consumers to make initial and continual purchases of a consumer product or a line of consumer products. The marketing system includes a game piece provided with a consumer product. The game piece includes game information for entry into a game, wherein the game information is utilized for the awarding of prizes. A security measure is included to protect the integrity of the consumer product and the game piece by preventing entry into the game until after the consumer product has been purchased.

### FIELD OF THE INVENTION

The present invention relates to a system and method for motivating consumers to make initial and continual purchases of a consumer product or a line of consumer products.

### BACKGROUND OF THE INVENTION

Over the years, games of chance have been used to market and promote sales of consumer products. To encourage the purchase of a consumer product a game piece is packaged with the consumer product. The consumer can then retrieve the game piece upon purchase of the consumer product. The game piece provides entry into the game, wherein the game can be an instant win or lottery type game.

In instant win type games, the game piece can immediately convey if a prize has been won. In lottery type game, the game piece provides a unique identifier which can be used to enter the lottery game. A listing of all entered identifiers is maintained, wherein at periodic time intervals a winner is selected form the listing of entered identifiers.

The consumer is encouraged to purchase additional products to obtain additional game pieces and chances of winning prizes. Such a system can generate excitement and enthusiasm towards a product, potentially resulting in an increase in sales and obtaining new consumers.

### SUMMARY OF THE INVENTION

The present invention provides a marketing system and method for motivating consumers to make initial and continual purchases of a consumer product or a line of consumer products. The consumers are motivated to make initial and continual purchases of participating consumer products by the prospect of winning a prize for each purchase of a participating consumer product.

The marketing system includes a game piece provided with a consumer product. The game piece includes game information for entry into a game, wherein the game information is utilized for the awarding of prizes.

Security measures are included which are associated with the consumer product and the game piece. The security measures protects the integrity of the consumer product and the game piece by preventing access to the game piece until after the consumer product has been purchased. Additionally, the security measure prevents viewing of the game information on the game piece.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows an exemplary game piece of the present invention;

FIG. 2 is flow chart on an instant win type game of the present invention;

FIG. 3 is flow chart on a non-instant win type game of the present invention;

FIG. 4 shows a game piece of the present invention affixed to a card board core;

FIG. 5 shows an exemplary game piece of FIG. 1 including a protective coating;

FIG. 6 is flow chart on a method of the present invention;

FIG. 7 is a schematic representation of a computer system of the present invention;

FIG. 8 shows a fluid container with a reactive coating to protect the game information;

FIG. 9 shows a fluid container includes an immersable game piece;

FIG. 10 shows the immersable game piece of FIG. 9;

FIG. 1 shows an edible article including a game piece of the present invention;

FIG. 12 shows the game piece of FIG. 1 including a sleeve portion; and

FIG. 13 shows an alternative edible article including a game piece of the present invention.

### DETAILED DESCRIPTION OF THE INVENTION

The present invention provides a system and method for motivating consumers to make initial and continual purchases of a consumer product or a line of consumer products. The consumers are motivated to make initial and continual purchases of participating consumer products by the prospect of winning a prize for each purchase of a participating consumer product.

A “game piece” is provided, which is packaged with the consumer products. Upon purchase and/or use of a participating consumer product, the consumer extracts the game piece, reading the information. The game piece provides entry into a game of chance, which can result in the consumer being awarded a prize. For example, in an instant win game, the game piece includes information which can be used to immediately convey prize winning information. The information on the game piece is protected by a security measure, which initially prevents viewing of the information.

Alternatively, the game piece can include an alphanumeric code, which is transmitted to a central location via telephone or over a computer network. The alphanumeric code is used to determine if the consumer has won a prize.

The present invention reads over the prior art in that is provides at least two levels of security to protect the integrity of the consumer product, the game piece, and the game. A first level of security is used to limit access to the game piece. A second level of security is used to limit access to the information on the game piece.

Referring now to the drawing figures in which like reference designators refer to like elements, there is shown in FIG. 1 a game piece 10 in accordance with the present invention. The game piece 10 includes a game identifier 12 and game information 14. In an instant win type game, the game information 14 takes the form of prize winning information. The prize winning information 14 can immediately conveys to the consumer whether or not a prize has been won. For example, the prize winning information 14 can be; “ONE FREE PRODUCT”, “YOU WIN $25.00,” or any other instant prize indicator. It is envisioned that every game piece can be a “winner,” wherein prizes can range from discount coupons to larger value prizes.

Alternatively, the game information 14 can be an alphanumeric code. Referring to FIG. 2, the consumer purchases the product 20, removing 22 the game piece 10 packaged therein. The game piece 10 includes game information 14 in the form of an alphanumeric code. To determine if a prize has been won the alphanumeric code is transmitted 24 to a computer system. The computer system includes a database(s), including listings of the winning codes and corresponding prizes. The transmittal of the alphanumeric code can optionally be done via telephone or over a computer network. The entered alphanumeric coded is compared 26 to listing of winning codes. If the alphanumeric code corresponds to a winning code, a specific prize, the consumer will be immediately informed 28.

In a non-instant win type game, for example, a lottery type game, the game information 14 can be an alphanumeric code. Referring to FIG. 3, the consumer purchases the product 20, removing 22 the game piece 10 packaged therein. The game piece 10 includes game information 14 in the form of an alphanumeric code. To register for the game the alphanumeric code and consumer contact information is transmitted 30 to a computer system. The computer system includes a database(s), storing 32 listings of all entered alphanumeric codes and corresponding consumers. The transmittal 30 of the alphanumeric code can optionally be done via telephone or over a computer network.

In the lottery type game, the alphanumeric code 14 does not correspond to a winning prize, but instead provides an identification which can be selected for a prize. At set time intervals, winning alphanumeric codes are randomly selected 34 from all the alphanumeric codes entered in the database(s). The winning consumers are then contacted 36, informing them of the winning prizes. In a lottery type game, each game piece 10 corresponds to one entry in the lottery game, wherein a single consumer can have multiple entries corresponding to the number of game pieces 10, i.e. number of products purchased.

To protect the integrity of the consumer products, the game, and the game pieces, the consumer product and/or game pieces include a security measure. The security measure prevents the game piece from being removed from a product and/or viewed until after the product has been purchased. The security measure provides at least a two step process for retrieving and viewing the game piece.

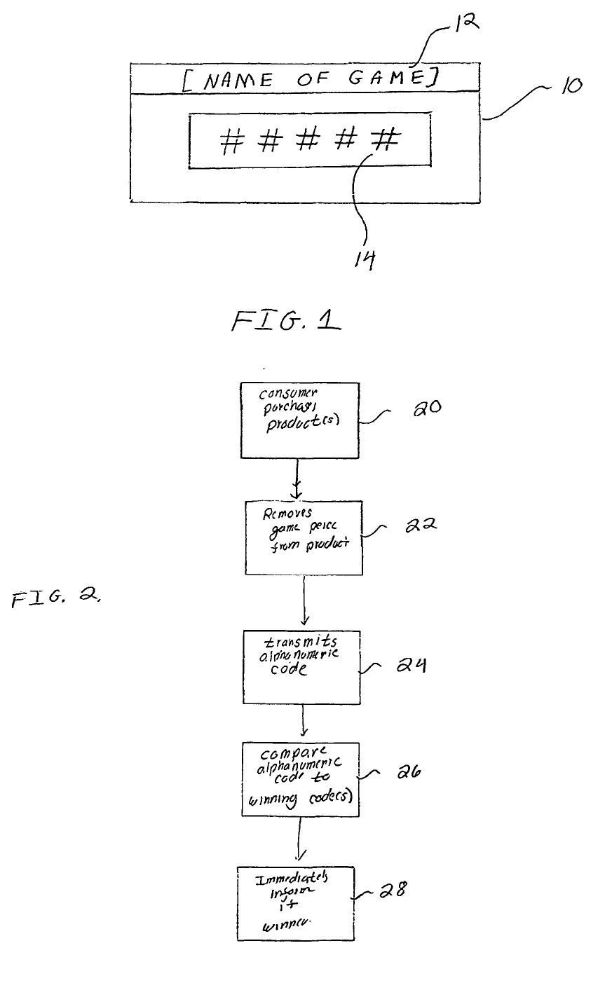

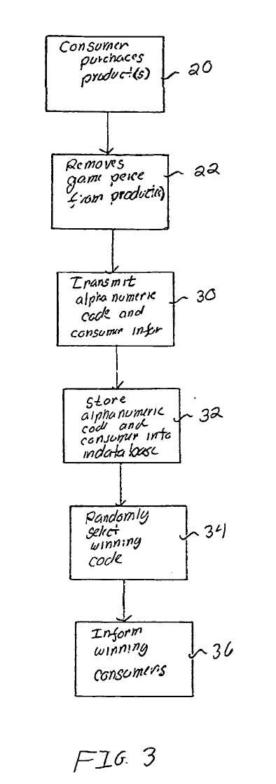

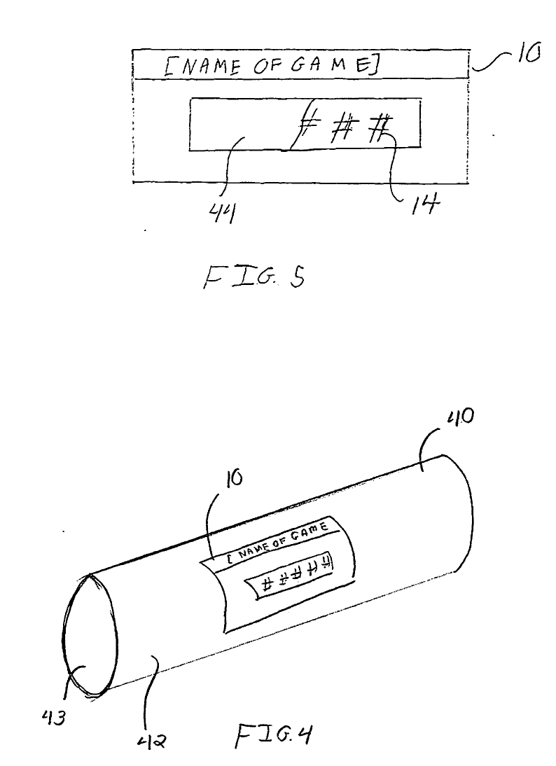

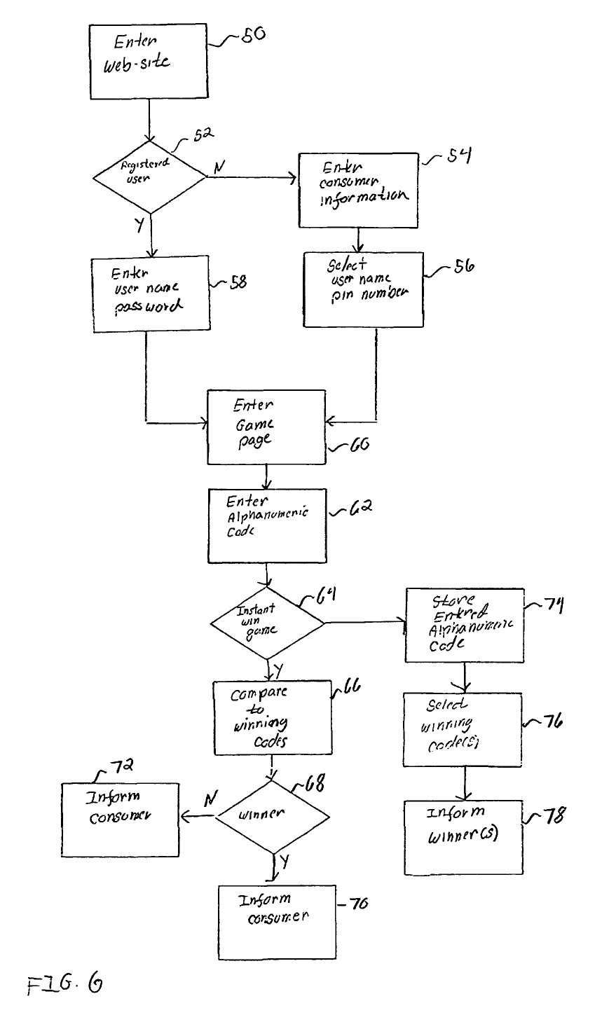

A security measure of the present invention prevents the game piece 10 from being removed from the product and/or viewed until after the consumer product has been completely utilized. Referring to FIG. 4, when the consumer product is a roll of toilet paper, paper towel, or any rolled product the game piece 10 can be affixed to the cardboard core 40 of the roll. The game piece 10 can be affixed to an exterior 42 or interior 44 surface of the cardboard core 40. Only after the roll has been completely used can the game piece 10 be viewed and/or removed.

Alternatively, the game piece 10 can be positioned between the toilet paper on the roll. As the toilet paper is used the game piece 10 will be revealed.

It is contemplated that the consumer product can be any rolled consumer product, such that the game piece 10 can be affixed to the core, or in the alternative, positioned within the consumer product about the roll in such a manner that access to the game piece 10 is limited to prevent removal/viewing until a substantial portion or all of the consumer product has been utilized.

Alternatively, when the consumer product or dry goods packaged in a container, the game piece 10 is positioned inside the container preventing removal of the game piece 10 until after all or substantially all of the consumer product has been consumed. For example, the game piece 10 can be removable attached to an inner surface of the container, such that the contents of the container prevent access to the game piece 10. Alternatively, the game piece 10 can be weighted, such that the game piece tends to lie at the bottom of the container. Access to the weight game piece requires that the consumer product be removed from the container.

Similarly, the game piece 10 is removable attached to an inner surface of the container, such that the consumption of the consumer product reveals the game piece 10. For example, the game piece 10 can be affixed to the bottom surface of a singly serving size ice cream container. The consumption of the ice cream reveals the game piece 10. The consumer product can further include, but not be limited to, pudding, Jell-O, fruit, etc.

It is contemplated that the game piece 10 can be affixed to any consumer product in such a manner that access to the game piece 10 is limited to prevent removal/viewing until a substantial portion or all of the consumer product has been utilized.

In a further embodiment, it is contemplated that the game piece 10 is positioned within the consumer product. For example, the consumer product can be a baby wipes, wherein baby wipes are stacked within a container. The game piece 10 in randomly positioned between the sheets of baby wipes, within the container. As the baby wipes are used the game piece 10 will eventually be revealed.

It is contemplated that the game piece 10 can be positioned within any stacked consumable product, through use of which reveals the game piece.

Alternatively, it is contemplated that the game piece 10 is imbedded within the consumer product, through use of which reveals the game piece 10. For example, the game piece is imbedded in a bar of soap. As the bar of soap is used, the game piece will be revealed. Similarly, the game piece can be imbedded within a container of car wax. As the car wax is used the game piece 10 will ultimately be revealed.

It is contemplated that the game piece 10 can be imbedded within any consumable product, through use of which reveals the game piece.

An alternative or additional security measures can also include a means for preventing the consumer from instantly reading a game piece 10 upon removal from the consumer product. Referring to FIG. 5, the game information 14 is covered with a protective coating 44. The protective coating 44 can take the form of a removable coating, for example, a scratch off coating which the consumer scratches away to reveal the underlying game information 14. It is contemplated that the game piece 10 can include any protective coating 44 which must be removed to reveal the underlying information.

Alternatively, the protective coating 44 can be a reactive coating, wherein an environmental change adjacent to the reactive coating causes a change in the reactive coating, revealing the underlying game information 14. The reactive coating can be a thermo reactive coating, wherein the thermo reactive coating changes in response to a change in temperature. For example, cold water can be applied to the game piece 10 and thermo reactive coating, resulting in a change in color of the thermo reactive coating, revealing the underlying information. It is contemplated that the game piece 10 can include any reactive coating, which reacts with an environmental change, such as temperature, light, water, etc., to reveal the underlying information.

Similarly, the game information 14 can be applied to the game piece 10 with a reactive material, a reactive ink, wherein an environmental change causes a change in the reactive ink revealing the underlying information. The reactive ink can be a thermo reactive ink, wherein the thermo reactive ink changes color in response to a change in temperature. For example, cold water can be applied to the game piece 10 and thermo reactive ink, resulting in a change in color of the thermo reactive ink, revealing the game information 14. It is contemplated that the game piece can include any reactive ink, which reacts with an environmental change, such as temperature, light, water, etc., to reveal the game piece information.

A further security measure can include linking the consumer product to the game piece 10. For example, the UPC code on the consumer product can include a code number which is printed on the purchase receipt, i.e. a proof of purchase. The receipt and/or code number is then required for redemption of the prize in instant win type games or for entering the alphanumeric code in the database(s). For example, the receipt and alphanumeric codes are entered into the database(s), wherein the receipt code is used as in indicator of purchase of a participating consumer product. Without entry of the receipt code the alphanumeric code will be rejected, preventing entry into the game.

It is envisioned that the security measures can be used in unison or in combinations, to protect the integrity of the consumer products, the game, and the game pieces.

Referring to FIG. 6, the present invention can include a web site 50 maintained on a computer system directed to the administration of the game. A consumer enters the game through a registration page. If the consumer is not a registered used 52, the consumer registers by providing consumer information 54, including contact information. The consumer is then provided with, or can select, a user name and password 56. The consumer enters the game 60 by providing the game information 14 from the game piece 10 into the computer system through the web site, enter the alphanumeric code 62. After the initial registration, the consumer need only entering the user name and password 60 to enter additional alphanumeric codes 62 from additional game pieces. The registration data will be maintained on a database(s) on the computer system.

In an instant win type game 64, upon entering, the alphanumeric code will be compared 66 to a listing of winning codes. If the alphanumeric code corresponds to a winning code 68, the consumer will be instantly informed if a prize has been won 70. This can take the form of forwarding the consumer to a winner's page. Alternatively, an e-mail can be instantly sent to the consumer. Similarly, if the alphanumeric code dose not corresponds to a winning code 68, the consumer will like wise be instantly informed 72.

In a non-instant win type game 64, the consumer will enter a game by entering the alphanumeric code 54 in the database(s). The alphanumeric code will be stored 74 in the database(s), linking the entered code to the consumer. There is no limit to the number of times the consumer can enter the game, such that the more products purchased the more chances of winning. At set time periods, for example, once a month, winning alphanumeric code(s) will be selected from the database(s) 76. The corresponding winner(s) will then be informed 78 via the contact information, for example, through e-mail.

The game can also be a combination of the instant win and lottery type game, wherein everybody who enters the game will win something. For example, each consumer who enters the game will receive discount coupons or some other type of prize. The consumer will also be registered for the lottery game. As with the lottery only game, there is no limit to the number of times a consumer can enter.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, flash memory, disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

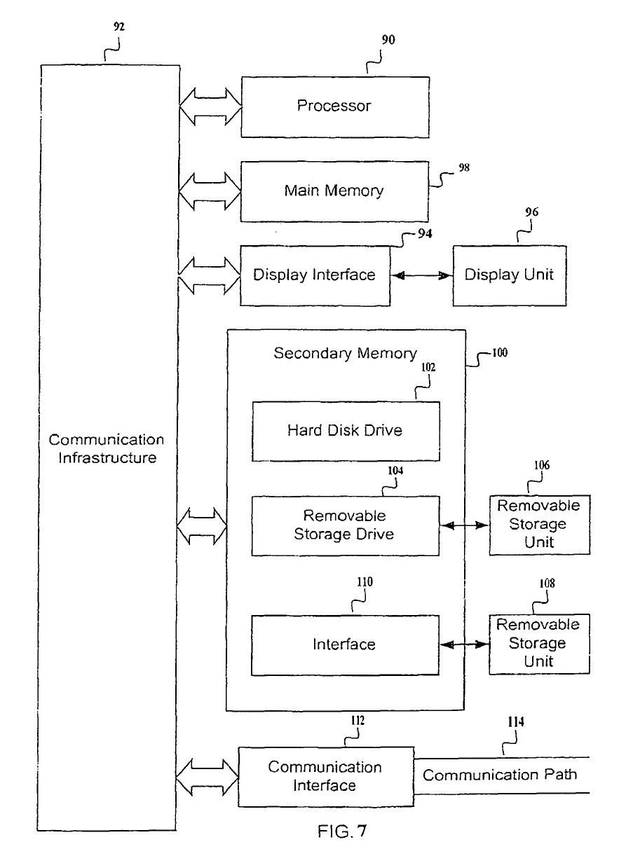

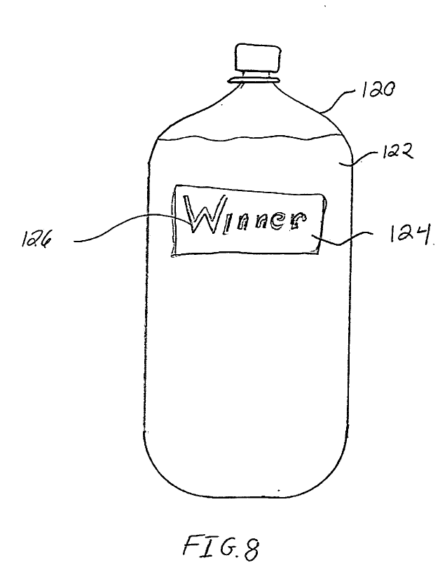

FIG. 7 is a block diagram of a computer system useful for implementing an embodiment of the present invention. The computer system includes one or more processors, such as processor 90. The processor 90 is connected to a communication infrastructure 92 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 94 that forwards graphics, text, and other data from the communication infrastructure 92 (or from a frame buffer not shown) for display on the display unit 96. The computer system also includes a main memory 98, preferably random access memory (RAM), and may also include a secondary memory 100. The secondary memory 100 may include, for example, a hard disk drive 102 and/or a removable storage drive 104, representing a floppy disk drive, a magnetic tape drive, an optical disk drive, etc. The removable storage drive 104 reads from and/or writes to a removable storage unit 106 in a manner well known to those having ordinary skill in the art. Removable storage unit 106, represents a floppy disk, magnetic tape, optical disk, etc. which is read by and written to by removable storage drive 104. As will be appreciated, the removable storage unit 106 includes a computer usable storage medium having stored therein computer software and/or data.

In alternative embodiments, the secondary memory 100 may include other similar means for allowing computer programs or other instructions to be loaded into the computer system. Such means may include, for example, a removable storage unit 108 and an interface 110. Examples of such may include a program cartridge and cartridge interface (such as that found in video game devices), a removable memory chip (such as an EPROM, or PROM) and associated socket, and other removable storage units 108 and interfaces 110 which allow software and data to be transferred from the removable storage unit 108 to the computer system.

The computer system may also include a communications interface 112. Communications interface 112 allows software and data to be transferred between the computer system and external devices. Examples of communications interface 112 may include a modem, a network interface (such as an Ethernet card), a communications port, a PCMCIA slot and card, etc. Software and data transferred via communications interface 112 are in the form of signals which may be, for example, electronic, electromagnetic, optical, or other signals capable of being received by communications interface 112. These signals are provided to communications interface 112 via a communications path (i.e., channel) 114. This channel 114 carries signals and may be implemented using wire or cable, fiber optics, a phone line, a cellular phone link, an RF link, and/or other communications channels.

In this document, the terms “computer program medium,” “computer usable medium,“ and “computer readable medium” are used to generally refer to media such as main memory 98 and secondary memory 100, removable storage drive 104, a hard disk installed in hard disk drive 102, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 98 and/or secondary memory 100. Computer programs may also be received via communications interface 112. Such computer programs, when executed, enable the computer system to perform the features of the present invention as discussed herein. In particular, the computer programs, when executed, enable the processor 90 to perform the features of the computer system. Accordingly, such computer programs represent controllers of the computer system.

In an embodiment, the game piece of the present invention is incorporated into the container of the consumer product. Referring now to FIG. 8, the container is a fluid container 120 for storing fluid 122 for sale. Prior to sale the fluid 122 is maintained in the container 120 in a sealed condition. At least a portion of the container 120 includes a reactive coating 124. The reactive coating 124 can be applied to an exterior surface or, for translucent containers, to the interior surface of the container 120. Optionally, a reactive material can be incorporated to the container 120.

The reactive coating 124 reacts to an environmental change adjacent to the reactive coating 124, for example causing a change in color of the reactive coating 124. The environmental reaction reveals the underlying game information 126. A color change can be used to immediately indicate if the container 120 is a winner. Alternatively, the reactive coating 124 is applied to the container 120 to provide game information 126 is in the form of an alphanumeric code. The alphanumeric code is used to provide instant winner game information 126 or game information 126 for entry into a lottery type game as previously describe.

In an embodiment the reactive coating 124 is a thermo reactive coating, wherein the thermo reactive coating changes in response to a change in temperature. For example, the container 120 is placed in a refrigeration unit, decreasing the temperature of the container 120 and enclosed fluid 122. The decrease in temperature causes the reactive coating 124 to change color, revealing the underlying game information 126. It is contemplated that the container 120 can include any reactive coating 124, which reacts with an environmental change, such as temperature, light, water, etc., to reveal the underlying information 126.

Alternatively, the reactive coating 124 is a pressure sensitive coating. The reactive coating 124 reacts to change in pressure inside the container 12, revealing the underlying game information 126. When the fluid 122 is packaged within the container 120, the fluid 122 is sealed within the container at a first pressure (P1). The first pressure applies a first force to the surface of the container 120 which is sensed by the reactive coating 124. At the first pressure, the game information 126 is protected from viewing by the reactive coating 124.

Upon purchase of the consumer product, the container 120 is opened, allowing access the fluid 122. The opening of the container 120 breaks the seal, resulting in a change of pressure inside the container. The pressure in the container changes from the first pressure (P1) to a second pressure (P2). The change in pressure is sensed by the reactive coating 124, resulting in the reactive coating 124 changing color revealing the protected game information 126.

It is contemplated that the fluid 122 is sealed in the container 124 at a pressure greater then atmospheric pressure, such that the first pressure is greater then the second pressure. The reactive coating 124 senses and reacts to the decrease in pressure, revealing the game information 126.

Alternatively, the fluid 122 is sealed in the container 124 at a pressure less then atmospheric pressure, such that the first pressure is less then the second pressure. The reactive coating 124 senses and reacts to the increase in pressure, revealing the game information 126.

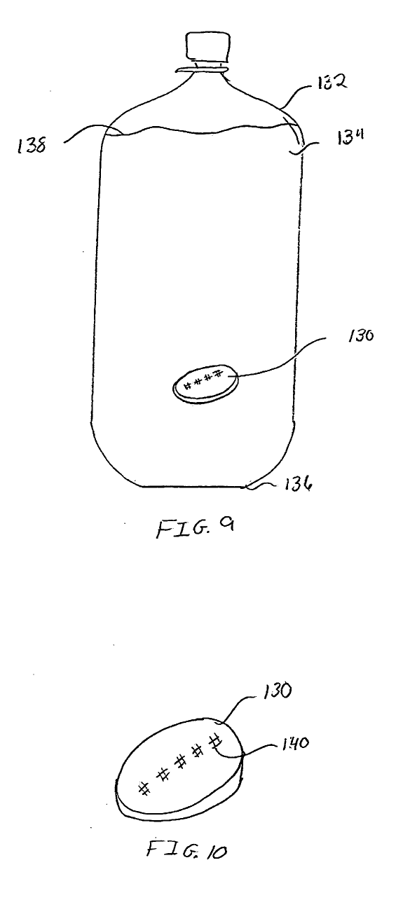

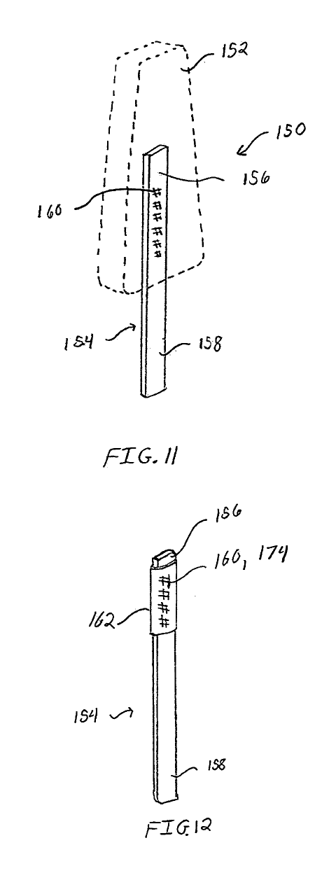

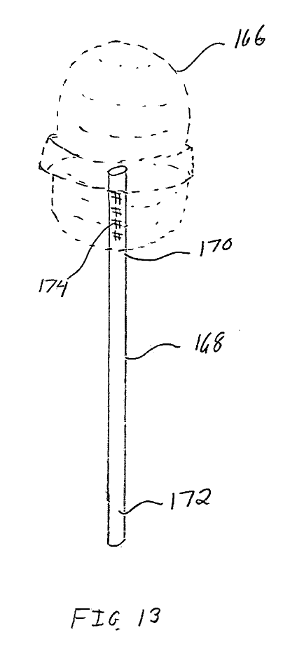

Referring to FIGS. 9 and 10, a game piece 130 of the present invention is positioned within a fluid container 130, such that the game piece 130 floats freely within the fluid 134. When the fluid 134 is packaged within the container 132, the fluid 134 is sealed within the container at a first pressure (P1). Upon purchase of the consumer product, the container 132 is opened, allowing access the fluid 134. The opening of the container 132 breaks the seal, resulting in a change of pressure inside the container 132. The pressure in the container 132 changes from a first pressure (P1) to a second pressure (P2).

A reaction to the change in pressure by the game piece 130 is used to indicate if the game piece 130 is a winner. A winning game piece 130 senses the change in pressure resulting in the reaction. Non-winning game pieces 130 do not sense the change in pressure and have no reaction.

At the first pressure, the game piece 130 is negatively buoyant, such that the game piece 130 settles to the bottom 136 of the container 132. When the container 132 is opened, breaking the seal, changing the pressure in the container 132 from the first pressure to the second pressure the buoyancy of the game piece 130 changes from negative to positive. The positively buoyant game piece 130 floats to the top 138 of the fluid 134 indicating that the game piece 130 is a winner. If the game piece 130 is not a winner the game piece 130 will remain negatively buoyant.

Alternatively, at the first pressure, the game piece 130 is positively buoyant, such that the game piece 130 the floats to the top of the fluid 134. When the container 132 is opened, breaking the seal, changing the pressure in the container 132 from the first pressure to the second pressure the buoyancy of the game piece 130 changes from positive to negative. The negatively buoyant game piece 130 sinks to the bottom 136 of the container 132 indicating that the game piece is a winner. If the game piece 130 is not a winner the game piece 130 will remain positively buoyant.

The change in buoyancy of the game piece is cause by a change in density of the fluid 134. As described by the Ideal Gas Law,
PV=nRT (1)
wherein;
P=pressure of the fluid
V=volume of the fluid
n=number of moles
R=the universal gas constant. The density D of a fluid is defined as;
   D=M/V (2)
   wherein M=mass of the fluid 134. The substitution of equation (2) into equation (1) results in a relationship between the pressure and density of the fluid 134;
   P=(nRT/M)D (3).
   The expression (nRT/M) will remain substantially constant for the fluid 134 within the container 132, such that the density of the fluid 134 is proportional to the pressure of the fluid 134 in the container 132. At the first pressure, the fluid 134 has a first density (D1) and at the second pressure, the fluid 134 has a second density (D2), wherein the first density is different from the second density.

For example, when the fluid 134 is packaged within the container 132, the fluid 134 is sealed within the container 132 at a first pressure (P1) having a first density (D1). The density of the game piece 130 is such that the game piece 130 has positive buoyancy in the first density (D1).

Upon purchase of the consumer product, the container 132 is opened, allowing access the fluid 134. The opening of the container 132 breaks the seal, resulting in a change of pressure inside the container 132. The pressure in the container changes from the first pressure (P1) to a second pressure (P2), wherein the second pressure (P2) is less then first pressure (P1). Using the relation ship developed is equation (3) is follows the second density (D2) of the fluid 134 at the second pressure (P2) is less then the first density (D1). The density of the game piece 130 is such that the game piece 130 has a negative buoyancy in the second density (D2), resulting in the game piece 130 sinking to the bottom 136 of the container 132.

Similarly, when the fluid 134 is packaged within the container 132, the fluid 134 is sealed within the container 132 at a first pressure (P1) having a first density (D1). The density of the game piece 130 is such that the game piece 130 has negative buoyancy in the first density (D1).

Upon purchase of the consumer product, the container 132 is opened, allowing access the fluid 134. The opening of the container 132 breaks the seal, resulting in a change of pressure inside the container 132. The pressure in the container changes from a first pressure (P1) to a second pressure (P2), wherein the second pressure (P2) is greater then first pressure P1. Using the relation ship developed is equation (3) is follows the second density (D2) of the fluid 134 at the second pressure (P2) is greater then the first density (D1). The density of the game piece 130 is such that the game piece 130 has a positive buoyancy in the second density D2, resulting in the game piece 130 floating to the top 138 of the fluid 134.

In an alternative embodiment, the game piece reacts 130 a change in pressure, with a resulting change in volume. As describe above, when the fluid 134 is packaged within the container 132, the fluid 134 is sealed within the container 132 at a first pressure (P1) having a first density (D1). The game piece 130 is made of a compressible material, such that the first pressure compresses the game piece 130 to a first volume. The density of the game piece 130 in the compressed state is such that the game piece 130 has negative buoyancy in the first density (D1).

Upon purchase of the consumer product, the container 132 is opened, allowing access the fluid 134. The opening of the container 132 breaks the seal, resulting in a change of pressure inside the container 132. The pressure in the container changes from a first pressure (P1) to a second pressure (P2), wherein the second pressure (P2) is less then first pressure (P1). At the second pressure (P2) the volume of the game piece 130 increases to a second volume. The increase in volume of the game piece 130 is such that the game piece 130 becomes positively buoyant in the fluid 134 at the second pressure (P2), resulting in the game piece 130 floating to the top 138 of the fluid 134.

In an alternative embodiment, when the fluid 134 is packaged within the container 132, the fluid 134 is sealed within the container 132 at a first pressure (P1) having a first density (D1). The game piece 130 is made of a compressible material, such that at the first pressure (P1) the game piece 130 has a first volume. The density of the game piece 130 at the first volume is such that the game piece 130 is positively buoyant in the first density (D1).

Upon purchase of the consumer product, the container 132 is opened, allowing access the fluid 134. The opening of the container 132 breaks the seal, resulting in a change of pressure inside the container 132. The pressure in the container changes from a first pressure (P1) to a second pressure (P2), wherein the second pressure (P2) is greater then first pressure (P1). At the second pressure (P2) the volume of the game piece 130 decreases to a second volume. The decrease in volume of the game piece 130 is such that the game piece 130 is negatively buoyant in the fluid 134 at the second pressure (P2), resulting in the game piece 130 sinking to the bottom 136 of the container 132.

Game piece 132 is can further include game information 140 in the form of alphanumeric codes. The alphanumeric code can be used to provide instant winner game information or game information for entry into a lottery type game as previously describe.

Referring to FIG. 11, a game piece of the present invention is shown as a device 150 for holding an edible article 152. For example, edible article 152 is a frozen product and the device 150 is a POPSICLE stick 154 having an upper portion 156 and a lower portion 158. The upper portion 156 of the POPSICLE stick 154 is embedded within the frozen product 152, such that the upper portion 156 is protected from being viewed. Upon consumer of the frozen product 152, by the consumer, the upper portion 156 of the POPSICLE stick 154 is revealed.

The upper portion 156 of the POPSICLE stick 154 includes game information 160. In an instant win type game, the game information 160 takes the form of prize winning information. Alternatively, the game information 160 can be an alphanumeric code. The alphanumeric code is used to provide instant winner game information 160 or game information 160 for entry into a lottery type game as previously describe. The game information 160 is imprinted directly on the POPSICLE stick 154, wherein the ink is non-soluble, non-toxic, ink.

Alternatively, as shown in FIG. 12, the game information 160 is imprinted on a sleeve 162, or wrap, which is securely positionable about the upper portion 156 of the POPICLE stick 154. The sleeve 162 is secured to the upper portion 156 of the POPICLE stick 154 with a non-toxic adhesive material 164.

Referring to FIG. 13, the edible article 152 is a candy, such as a lollipop 166, and the device is a lollipop stick 168 for holding the lollipop 166. The lollipop stick 168 includes an upper portion 170 and a lower portion 172. The upper portion 170 of the lollipop stick 168 is embedded within the lollipop 168, such that the upper portion 170 is protected from being viewed. Upon consumer of the lollipop 166, by the consumer, the upper portion 170 of the lollipop stick 168 is revealed.

The upper portion 170 of the lollipop stick 168 includes the game information 174. In an instant win type game, the game information 174 takes the form of prize winning information. Alternatively, the game information 174 can be an alphanumeric code. The alphanumeric code is used to provide instant winner game information 174 or game information 174 for entry into a lottery type game as previously describe. The game information 174 is imprinted directly on the lollipop stick 168, wherein the ink is non-soluble, non-toxic, ink.

Alternatively, as shown in FIG. 12, the game information 174 is imprinted on a sleeve 162, or wrap, which is securely positionable about the upper portion 170 of the lollipop stick 168. The sleeve 162 is secured to the upper portion 170 of the lollipop stick 168 with a non-toxic adhesive material 164.

In a further embodiment, the game piece is used for a match maker type game. For example, to facilitate meeting people in a social setting, a night club, party ,or the like, products including game pieces are provides to the patrons. The game information on each of the game pieces takes the form of symbols or alphanumeric codes. Games pieces are provided with matching game information. The objective of the game is to find the matching game information, by meeting the other patron and comparing game pieces and game information.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A marketing system for encouraging a consumer to make initial and continually purchases of a consumer product by allowing entry into a game of chance with the purchase of the consumer product, comprising:
a game piece including game information for entry into the game, the game piece being packaged with the consumer product;
a first security measure associated with the consumer product and the game piece, the first security measure preventing consumer access to the game piece until after the consumer product has been purchased; and
a second security measure associated with the game piece, the second security measure preventing viewing of the game information game piece.

2. The marketing system of claim 1, further comprising a third security measure which prevents entry into the game until after the consumer product has been purchased.

3. The marketing system of claim 2, wherein the third security measure is a purchase receipt required for entry into the game.

4. The marketing system of claim 2, wherein the third security measure is a receipt code provided on a purchase receipt and required for entry into the game.

5. The marketing system of claim 1, wherein the game is an instant win game.

6. The marketing system of claim 5, wherein the game information immediately conveys if a prize has been won.

7. The marketing system of claim 5, wherein the game information is an alphanumeric code.

8. The marketing system of claim 5, wherein the game is a non-instant win game.

9. The marketing system of claim 8, wherein the game information is an alphanumeric code.

10. The marketing system of claim 1, wherein the consumer product is packaged in a container.

11. The marketing system of claim 10, wherein first security measure includes positioning the game piece within the container such that all or a substantially portion of the consumer product must be consumed to provide access to the game piece.

12. The marketing system of claim 11, wherein the first security measure includes affixing the game piece to an inner surface of the container.

13. The marketing system of claim 1, wherein the first security measure includes imbedding the game piece within the consumer product, such that all or a substantially portion of the consumer product must be consumed to provide access to the game piece.

14. The marketing system of claim 13, wherein the consumer product is a bar of soap.

15. The marketing system of claim 1, wherein the second security measure includes a protective coating covering the game information on the game piece.

16. The marketing system of claim 15, wherein the protective coating is a removable coating.

17. The marketing system of claim 15, wherein the protective coating is a reactive coating.

18. The marketing system of claim 1, further comprising a computer system including a database, the computer system being configured to receive entries of the game information.

19. The marketing system of claim 18, wherein the game information is an alphanumeric code.

20. The marketing system of clam 18, wherein the database includes a listing of winning codes.

21. The marketing system of claim 20, wherein the computer system compares the alphanumeric code to the list of winning codes.

22. The marketing system of claim 18, wherein the database includes a listing of all entered alphanumeric codes.

23. The marketing system of claim 18, wherein the computer system selects a winning alphanumeric code from the list of all alphanumeric codes.

24. A marketing system for encouraging a consumer to make initial and continually purchases of a consumer product by allowing entry into a game of chance with the purchase of the consumer product, comprising:
a container, wherein the consumer product is packaged within the container a game piece including game information for entry into the game, the game piece being packaged with the consumer product;
a first security measure for preventing consumer access to the game piece and including positioning the game piece within the container such that all or a substantially portion of the consumer product must be consumed to provide access to the game piece; and
a second security measure for preventing viewing of the game information on the game piece and including a protective coating covering the game information on the game piece.

25. The marketing system of claim 24, further comprising a third security measure which prevents entry into the game until after the consumer product has been purchased.

26. A marketing system for encouraging a consumers to make initial and continually purchases of a consumer product by allowing entry into a game of chance with the purchase of the consumer product, comprising:
a game piece including game information for entry into the game, the game piece being packaged with the consumer product;
a first security measure associated with the game piece preventing viewing of the game information, and a second security measure for preventing entry into the game until after the consumer product has been purchased.

27. The marketing system of claim 26, wherein the third security measure is a purchase receipt required for entry into the game.

28. The marketing system of claim 26, wherein the third security measure is a receipt code provided on the purchase receipt

29. A method of encouraging a consumer to make initial and continually purchases of a consumer product by allowing entry into a game of chance with the purchase of the consumer product, comprising:
providing the consumer product for purchase;
providing a game piece packaged with the consumer product, the game piece including game information;
providing the game;
providing a first security measure associated with the consumer product and the game piece, the first security measure including a means for preventing access to the game piece until after the consumer product has been purchased;
providing a second security measure associated with the game piece, the second security measure including a mean for preventing viewing of the game information; and
awarding prizes based on the game information on the game piece.

30. The method of claim 29, further comprising providing a third security measure including a means for preventing entry into the game until after the consumer product has been purchased a

31. A food product, comprising:
an edible article;
a support device including an upper portion and a lower portion, wherein the upper portion is embedded within the edible article; and
game information positioned on the upper portion of the support device, wherein the game information provides entry into a game.

32. The food product of claim 31, wherein the edible article is a frozen product.

33. The food product of claim 31, wherein the edible article is a candy.

34. The food product of claim 31, wherein the support device is a stick.

35. The food product of claim 31, wherein the game information is imprinted on the support device.

36. The food product of claim 31, further comprising a sleeve removable attachable about the upper portion of the support device, wherein the game information is imprinted on the sleeve.

37. The food product of claim 31, wherein the game is an instant win game.

38. The food product of claim 31, wherein the game is a lottery game.
